(19) United States
(12) Patent Application Publication
(10) Pub. No.: US 2012/0263226 A1
(43) Pub. Date: Oct. 18, 2012

(54) SOURCE NODE AND SENDING METHOD THEREFOR

(75) Inventor: Hirohiko Inohiza, Rennes (FR)

(73) Assignee: CANON KABUSHIKI KAISHA, Tokyo (JP)

(21) Appl. No.: 13/432,282

(22) Filed: Mar. 28, 2012

(30) Foreign Application Priority Data
Apr. 14, 2011 (JP) 2011-090407

(51) Int. Cl. H04N 7/26

(52) U.S. Cl. 375/240.02; 375/E07.126

(57) ABSTRACT

When data either uncompressed or compressed at a predetermined compression ratio and high-compression data compressed at a compression ratio higher than the predetermined compression ratio are sent through different communication paths, if an error occurs on the communication path through which the data either uncompressed or compressed at the predetermined compression ratio is being sent, the data either uncompressed or compressed at a predetermined compression ratio is sent through the communication path used to send the high-compression data up to that time.

### BACKGROUND OF THE INVENTION

1. Field of the Invention

The present invention relates to a node and a sending method therefor in a wireless communication system that transfers data from a source node to a destination node using plural communication paths.

2. Description of the Related Art

Conventional methods for ensuring stable data transmission between nodes interconnected via a communication path with varying communication conditions include a method for generating the same data with different compression ratios and transmitting the resulting sets of compressed data via plural different communication paths.

For example, according to a technique disclosed in Japanese Patent Laid-Open No. 2000-78116, a sending device generates a high-quality signal and low-quality signal from the same digital broadcast data and sends the signals by shifting time and a receiving device receives and plays back the high-quality signal in a normal receive mode, but receives and plays back the low-quality signal in a failure mode.

Also, according to a technique disclosed in Japanese Patent Laid-Open No. 2004-32604, a sending device separately sends sets of data containing the same information and differing in compression ratio through plural transmission channels differing in transmission speed and a receiving device switches the transmission channel to be used, based on an error rate of the transmission channel used for reception.

However, with the conventional techniques described above, when only a communication path for use to transmit data with a low level of quality (high compression ratio) is available, the level of quality of the data transmitted through the communication path cannot be changed. Consequently, there is a problem in that if a communication path for transmission of data with a high level of quality (low compression ratio) becomes unavailable during transmission of video data, it is necessary to continue using low-quality video.

Also, with the conventional techniques described above, separate communication paths are established in advance for transmission of data with a high level of quality and transmission of data with a low level of quality. Consequently, there is a problem in that if both the communication paths are disconnected simultaneously, communication is totally disabled.

### SUMMARY OF THE INVENTION

The present invention provides a node and a sending method therefor capable of sending data with a high level of quality even if an error occurs on a communication path.

According to an aspect of the present invention, there is provided a source node that sends data to a destination node, the source node comprising: a sending unit that sends data either uncompressed or compressed at a predetermined compression ratio through a first communication path and send data compressed at a high compression ratio than the predetermined compression ratio through a second communication path different from the first communication path; and a changing unit that changes the compression ratio of data sent through the second communication path from the high-compression ratio into either uncompressed or the predetermined compression ratio in case that an error occurs on the first communication path.

Further features of the present invention will become apparent from the following description of exemplary embodiments (with reference to the attached drawings).

### BRIEF DESCRIPTION OF THE DRAWINGS

FIG. 1 is a diagram showing an exemplary network configuration of a wireless communication system;

FIG. 2 is a block diagram showing an internal configuration of a source node;

FIG. 3 is a block diagram showing an internal configuration of a destination node;

FIG. 4 is a diagram for illustrating an antenna control method of wireless nodes;

FIG. 5 is a diagram for illustrating a structure of a communication frame;

FIG. 6 is a diagram showing a detailed configuration of time-slot allocation information;

FIG. 7 is a diagram showing an operational sequence of a training process;

FIG. 8 is a diagram showing an operational sequence for transmitting video data;

FIG. 9 is a diagram for illustrating an outline of operations performed in case of an error;

FIG. 10 is a diagram showing an operational sequence according an embodiment of the present invention;

FIG. 11 is a diagram for illustrating an outline of operations performed to search for and use a new communication path;

FIG. 12 is a diagram showing an operational sequence for selecting a communication path anew again;

FIGS. 13A to 13C are diagrams showing allocations of an application data time-slot period;

FIG. 14 is a flowchart showing superframe processing at a source node;

FIGS. 15A and 15B are flowcharts showing superframe processing at a destination node;

FIG. 16A is a flowchart showing details of a time-slot allocation information generation process and FIG. 16B is a flowchart showing details of the process of selecting primary and secondary communication paths and determining video compression ratios; and

FIGS. 17A and 17B are diagrams showing examples of a communication quality table.

### DESCRIPTION OF THE EMBODIMENTS

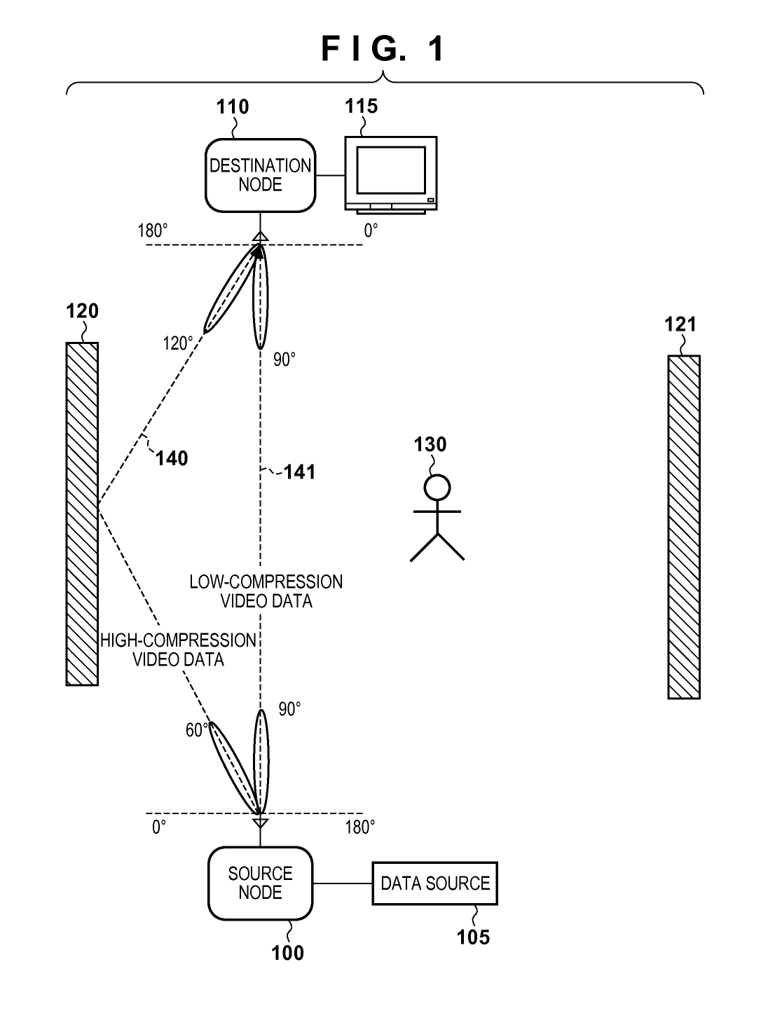

An embodiment of the present invention will be described in detail below with reference to the drawings. Configurations of a network and plural wireless nodes, a configuration of a communication frame, and control operation according to the present embodiment will be described with reference to FIGS. 1 to 17A and 17B.

FIG. 1 is a diagram showing an exemplary network configuration of a wireless communication system. The present network is a system designed to wirelessly transmit video data, where a source node 100 wirelessly transmits the video data acquired from a data source 105 to a destination node 110, which then outputs the video data received by the destination node 110 to a display 115.

The source node 100 and destination node 110 are wireless nodes each of which is equipped with a directional antenna and configured to be able to wirelessly transmit data by changing directivity angles for transmission and reception. Communication paths used to transmit video data include a reflected communication path 140 that uses reflecting objects 120 and 121 such as walls as well as a direct communication path 141. The communication paths 140 and 141 differ from each other in the transmission directivity angle of the source node 100 and reception directivity angle of the destination node 110.

According to the present embodiment, to improve reliability of data transmission, the source node 100 transmits video data with a high level of quality (low compression) and video data with a low level of quality (high compression) by selecting plural different communication paths. Consequently, even if a screening object 130 appears on the line of one of communication paths 140 or 141, the communications can be continued and it allows the video to be played back without interruption as long as the video data can be transmitted through another communication path.

The destination node 110 receives multiple sets of video data and uses low-compression video data preferentially. Among the plural communication paths selected by the source node 100, a first communication path used for transmission of low-compression data is referred to herein as a primary communication path, and another, second communication path is referred to as a secondary communication path. The secondary communication path usually transmits high-compression data, but it specially transmits low-compression data instead of high-compression data if an error persists on the primary communication path. Although one secondary communication path is used herein, this is not restrictive and two or more secondary communication paths may be used.

Incidentally, although low-compression data is transmitted on the primary communication path in the example described in the present embodiment, uncompressed data may be transmitted on the primary communication path. If uncompressed data is transmitted on the primary communication path, the phrase “low-compression data” in the following description can be changed to “uncompressed data.”

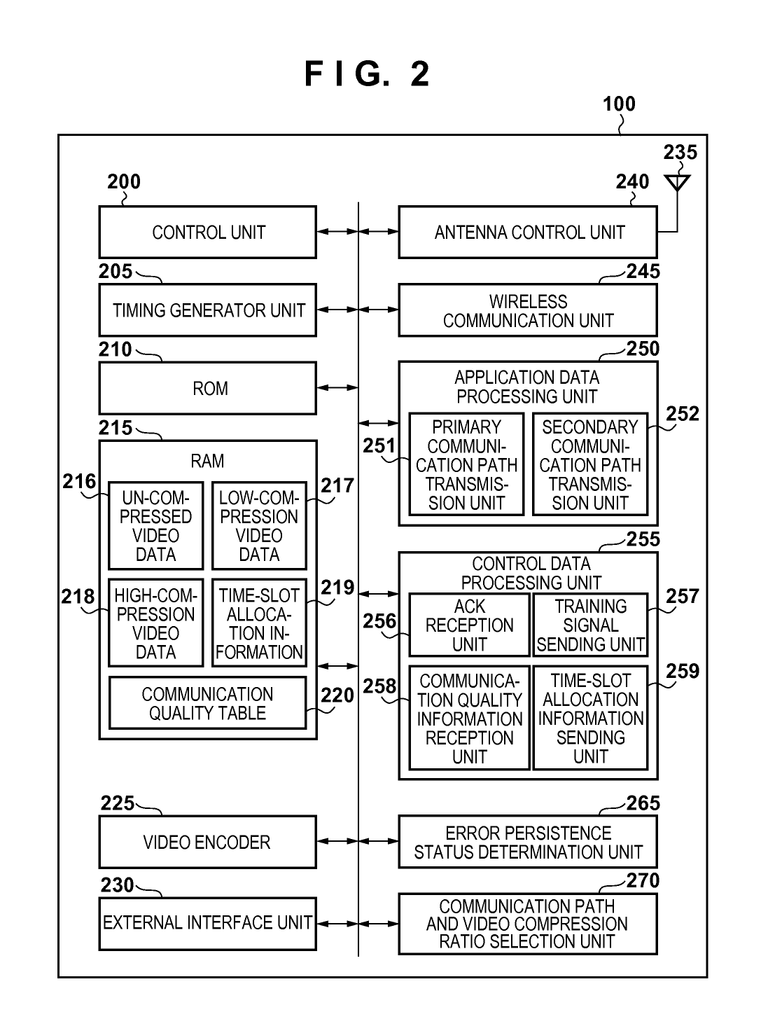

Now, an internal configuration of the source node 100 will be described with reference to a block diagram shown in FIG. 2. A control unit 200 controls operation of the entire source node 100 according to a program stored in a ROM 210. A timing generator unit 205 generates a timing to transmit or receive data. The timing to transmit or receive data is determined by time-slot allocation information 219. The ROM 210 is a memory adapted to store programs and various non-volatile parameters of the source node 100. A RAM 215 is a memory adapted to store various volatile parameters and data.

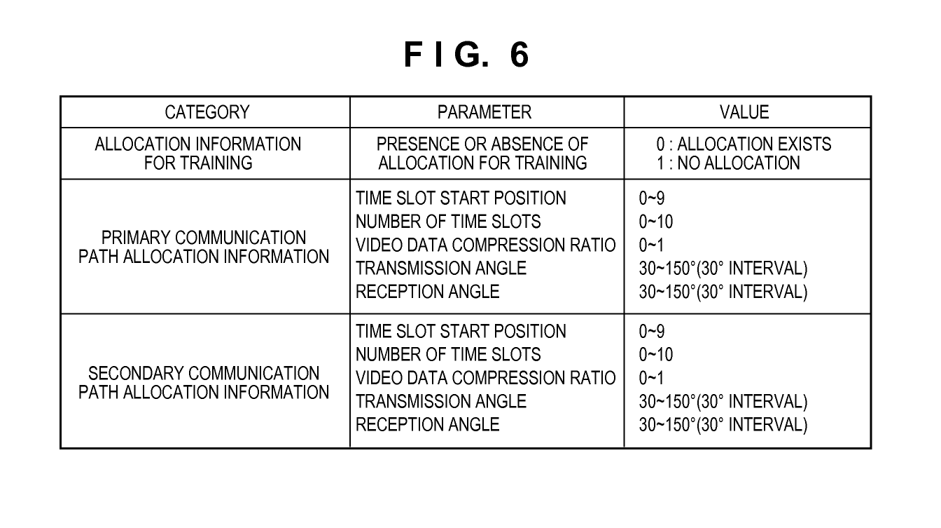

The RAM 215 stores uncompressed video data 216 received from the data source 105 as well as low-compression video data 217 and high-compression video data 218 compressed and generated by a video encoder 225 based on the uncompressed video data 216. Also, the RAM 215 stores the time-slot allocation information 219 that defines allocations of time slots in a communication frame. The time-slot allocation information 219 includes information about the presence or absence of an allocation for training in the communication frame, allocations for video data to be transmitted, antenna directivity angles, and compression ratios of video data. A detailed structure of the time-slot allocation information 219 will be further described later with reference to FIG. 6. Furthermore, the RAM 215 stores a communication quality table 220 that shows communication quality of communication paths formed by combinations of transmission/reception directivity angles between wireless nodes in the network.

The video encoder 225 applies a compression process to the uncompressed video data 216 and thereby generates the low-compression video data 217 and high-compression video data 218. An external interface unit 230 is an interface intended to receive the uncompressed video data 216 from the data source 105. An antenna control unit 240 controls transmission/reception directivity angles of the antenna 235 used to transmit and receive signals as radio waves during transmission and reception by a wireless communication unit 245. The wireless communication unit 245 performs signal processing for transmission and reception, including modulation and demodulation of wireless data.

An application data processing unit 250 packetizes video data to wireless packet and outputs resulting wireless packet to the wireless communication unit 245. The application data processing unit 250 includes a primary communication path transmission unit 251 and secondary communication path transmission unit 252. The primary communication path transmission unit 251 sends the low-compression video data 217 through the primary communication path according to the time-slot allocation information 219 and the secondary communication path transmission unit 252 sends the low-compression video data 217 or high-compression video data 218 through the secondary communication path according to the time-slot allocation information 219.

A control data processing unit 255 processes control data of a wireless protocol. The control data processing unit 255 includes an ACK reception unit 256, training signal sending unit 257, communication quality information reception unit 258, and time-slot allocation information sending unit 259. The ACK reception unit 256 receives an ACK/NAK from the destination node 110, indicating reception conditions of the video data transmitted through the primary communication path and secondary communication path. The training signal sending unit 257 sends a known signal for communication quality measurement. The communication quality information reception unit 258 receives communication quality information from the destination node 110 that has received the training signal. The time-slot allocation information sending unit 259 generates the time-slot allocation information 219 and sends the time-slot allocation information 219 to the destination node 110. The source node 100 generates the communication quality table 220 based on the communication quality information received from the destination node 110.

An error persistence status determination unit 265 determines whether or not an error persists on the primary communication path and secondary communication path, based on status of ACK received by the ACK reception unit 256. Based on the communication quality table 220 and error persistence status, a communication path and video compression ratio selection unit 270 selects one of the primary communication path and secondary communication path as the communication path to be used and determines the compression ratio of the video to be transmitted through the selected communication path.

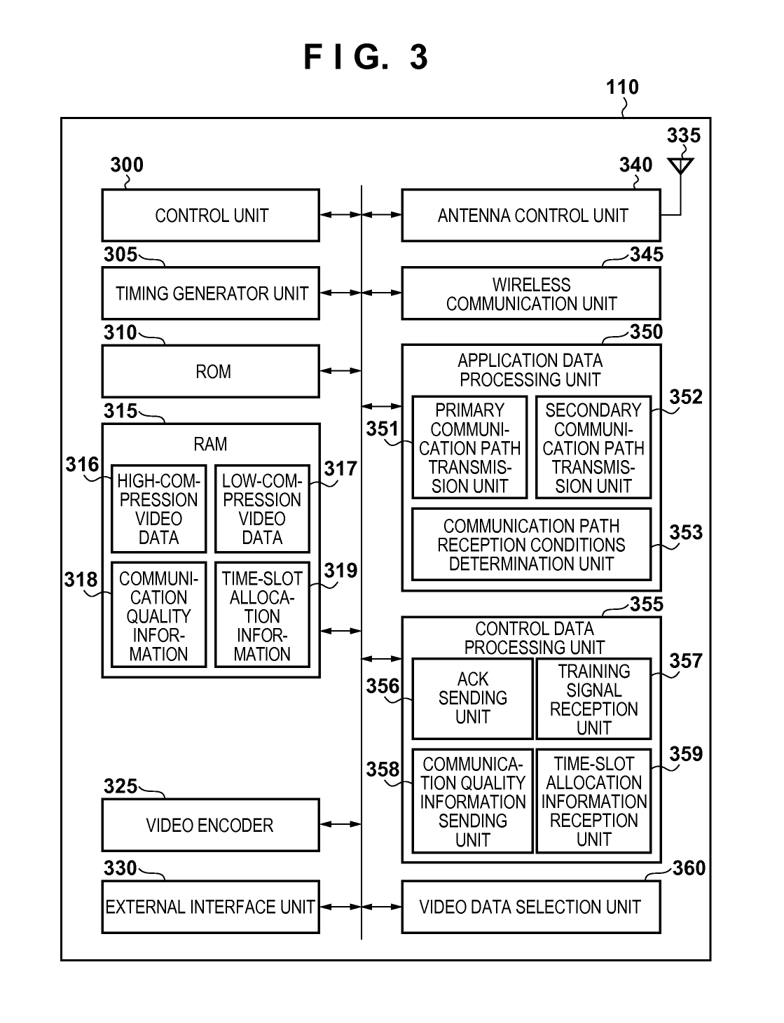

Next, an internal configuration of the destination node 110 will be described with reference to a block diagram shown in FIG. 3. A control unit 300 controls operation of the entire destination node 110 according to a program stored in a ROM 310. A timing generator unit 305 generates a timing to transmit or receive data. The timing to transmit or receive data is determined by time-slot allocation information 319 received through wireless communications. The ROM 310 is a memory adapted to store programs and various non-volatile parameters of the destination node 110. A RAM 315 is a memory adapted to store various volatile parameters and data.

The RAM 315 stores high-compression video data 316 received through wireless communication and low-compression video data 317 received through wireless communication. Also, the RAM 315 stores communication quality information that shows communication conditions of communication paths formed by combinations of transmission/reception directivity angles with respect to the source node 100. Furthermore, the RAM 315 stores the time-slot allocation information about allocations of time slots in a communication frame received through wireless communication.

A video decoder 325 applies a decompression process to the compressed video data selected by a video data selection unit 360. An external interface unit 330 is an interface intended to output the video data decompressed by the video decoder 325 to the display 115. An antenna control unit 340 controls transmission/reception directivity angles of the antenna 335 used to transmit and receive signals as radio waves during transmission and reception by a wireless communication unit 345. The wireless communication unit 345 performs signal processing for transmission and reception, including modulation and demodulation of wireless data.

An application data processing unit 350 extracts video data from received packets of wireless data. The application data processing unit 350 includes a primary communication path reception unit 351, secondary communication path reception unit 352, and communication path reception conditions determination unit 353. The primary communication path reception unit 351 receives the low-compression video data (317) via the primary communication path according to the time-slot allocation information 319. The secondary communication path reception unit 352 receives the high-compression video data 316 or low-compression video data 317 via the secondary communication path according to the time-slot allocation information 319. The communication path reception conditions determination unit 353 determines whether or not the respective video data have been received successfully via the primary communication path and secondary communication path.

A control data processing unit 355 processes control data of the wireless protocol. The control data processing unit 355 includes an ACK sending unit 356, training signal reception unit 357, communication quality information sending unit 358, and time-slot allocation information reception unit 359. The ACK sending unit 356 sends an ACK/NAK to the destination node 110, indicating the reception conditions of the primary communication path and secondary communication path determined by the communication path reception conditions determination unit 353. The training signal reception unit 357 measures the communication quality of communication paths by receiving a known signal. The communication quality information sending unit 358 sends each of communication quality information 318 about the communication paths resulting from measurements by the training signal reception unit 357 to the source node 100 all together. The time-slot allocation information reception unit 359 receives the time-slot allocation information 319 contained in the communication frame.

The video data selection unit 360 controls the video data to be output to the external interface unit 330, according to the reception conditions of the primary communication path and secondary communication path.

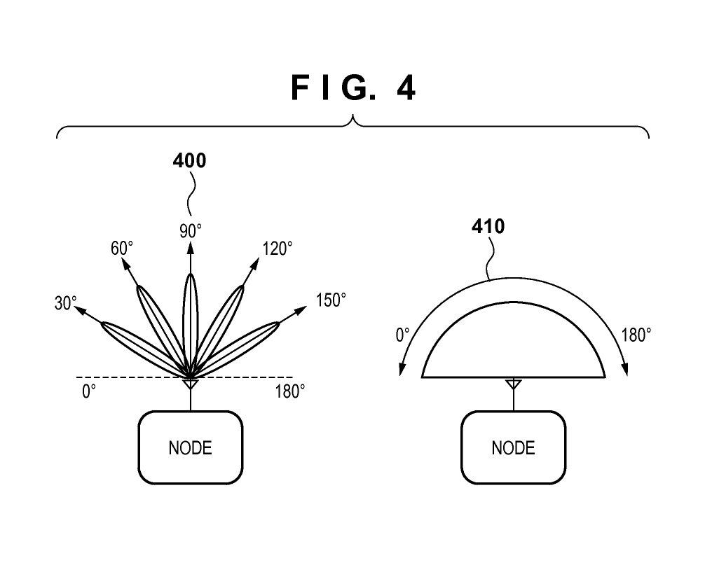

Next, an antenna control method of the wireless nodes according to the present embodiment will be described with reference FIG. 4. Each of the wireless nodes (source node 100 and destination node 110) is equipped with a directional antenna made up of plural antenna elements. A high directivity (narrow) mode 400 and low directivity (wide) mode 410 can be switched between each other by controlling phase of wireless signals sent and received by each antenna elements. Incidentally, the configuration of the antenna is not limited to this and an antenna of the high directivity mode 400 and an antenna of the low directivity (wide) mode 410 may be installed separately.

In the high directivity mode 400, the antenna can form a beam with one of five different directivity angle patterns by controlling the directivity angle at a resolution of 30° within a range of 30° to 150° (both inclusive). The range and resolution of directivity angles in the high directivity mode 400 are not limited to this. On the other hand, the wide mode 410 covers a wide range of directivity angles between 0° and 180°, but the range of directivity angles is not limited to this.

In the high directivity mode 400, although the coverage of the communication path is limited, since high antenna gain is available, data can be transmitted at a high rate. On the other hand, in the wide mode 410, although the coverage of the communication path is wider than the high directivity mode 400, since the antenna gain is lower than the high directivity mode 400, a lower transmission rate is available when the communication range is the same. According to the present embodiment, large-volume video data is sent and received in the high directivity mode 400 while small-volume control data is sent and received in the wide mode 410.

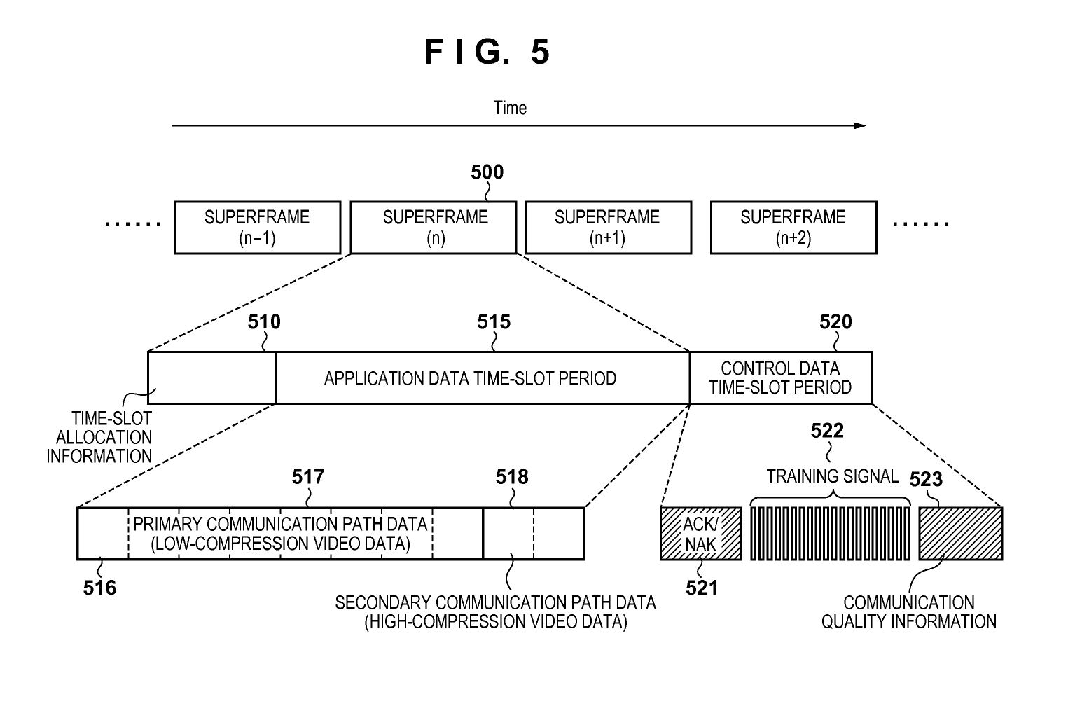

Next, a structure of a communication frame in the wireless communications system will be described with reference FIG. 5. Communication frames in FIG. 5 are superframes 500 of a fixed length and are sent with a repetition period that corresponds to a validity period of application data. Each superframe 500 includes three separate periods: time-slot allocation information 510, an application data time-slot period 515, and a control data time-slot period 520.

The time-slot allocation information 510 includes information about a layout of the application data time-slot period 515 and control data time-slot period 520 as well as send/receive conditions. In order to receive the video data as well as to send and receive the control data, the destination node 110 needs to be able to properly receive the time-slot allocation information transmitted by the source node 100. Incidentally, a detailed structure of the time-slot allocation information will be further described later with reference to FIG. 6.

In the application data time-slot period 515, time slots are allocated to the source node 100 that is a wireless node adapted to send video data. The application data time-slot period 515 is organized in units of time slots 516 and made up of ten time slots.

According to the present embodiment, the source node 100 uses two communication paths—the primary communication path and secondary communication path—to transmit low-compression video data and high-compression video data generated from the same uncompressed video data. The two types of video data differ in the amount of data: a data period 517 for the primary communication path occupies eight time slots and a data period 518 for the secondary communication path occupies two time slots. If video data is transmitted using two different communication paths in this way, the video data can be played back within a validity period of the video data as long as the data can be received through at least one of the communication paths.

The control data time-slot period 520 includes three types of control data: an ACK/NAK 521, a training signal 522, and communication quality information 523. The ACK/NAK 521 is sent by the destination node 110, indicating whether or not the destination node 110 has properly received data contained in the application data time-slot period 515 through the primary communication path and secondary communication path. The training signal 522 is a known signal made up of a collection of small data packets and sent from the source node 100 to measure the communication quality of the communication paths.

According to the present embodiment, the source node 100 and destination node 110 use the high directivity mode 400 to transmit application data. Therefore, the training signal 522 is sent in the high directivity mode 400 by changing the directivity angle. Furthermore, by receiving the training signal 522 by changing the directivity angle, the destination node 110 can measure the communication quality of the communication paths formed by combinations of transmission/reception directivity angles. The communication quality information 523 is sent by the destination node 110 and contains the communication quality information about the communication paths obtained by measurements upon reception of the training signal 522.

Next, a structure of the time-slot allocation information will be described with reference to FIG. 6. The time-slot allocation information contains parameters classified into three categories: allocation information for training, primary communication path allocation information, and secondary communication path allocation information. FIG. 6 shows parameters in each category and valid values for each parameter.

First, the parameter contained in the allocation information for training will be described. The “presence or absence of allocation for training” indicates whether or not a training signal is contained in the time slot period for control data in the superframe. A value of “0” for the parameter indicates that there is no allocation, and neither the source node 100 nor the destination node 110 operates in the training signal interval. On the other hand, a value of “1” for the parameter indicates that there is an allocation, and the source node 100 sends a training signal and receives communication quality information in time slots for subsequent communication quality information from the destination node 110. The destination node 110 receives the training signal, measures communication quality, and sends the measured communication quality in time slots for subsequent communication quality information to the source node 100.

Next, the parameters contained in the primary communication path allocation information will be described. The “time slot start position” indicates from what time slot of the application data time-slot period the time slots for the primary communication path begins. In the example of FIG. 5, since the “application data time-slot period” includes 10 time slots, valid values are “0” to “9.” The next parameter, “number of time slots,” indicates the number of time slots used for the primary communication path. Valid values are “0” to “10.” A value of “0” indicates that no video data is transmitted through the primary communication path. If compare the primary communication path data in a period 517 in FIG. 5, the time slot start position is set to “0” and the number of time slots is set to “8.”

The next parameter, “video data compression ratio” indicates the compression ratio of a compression process applied by the encoder of the source node 100 to the video data originally received from the data source 105. Valid values are “0” and “1.” For example, if the received video data is 500 MB in size and the video data transmitted through the primary communication path is 400 MB, the compression ratio is 400/500=0.8. The destination node 110 makes the video decoder perform a decompression process based on this parameter.

The next parameter, “transmission angle” indicates the antenna directivity angle set by the source node 100 to send video data through the primary communication path. Specifically, any one of the values from 30° to 150° in steps of 30° is set, as shown in FIG. 4. The next parameter, “reception angle” indicates the antenna directivity angle set by the destination node 110 to receive video data through the primary communication path. As with the transmission angle, any one of the values from 30° to 150° in steps of 30° is set, as shown in FIG. 4. For example, on the primary communication path shown in FIG. 1, both the transmission angle and reception angle are 90°.

Finally, the parameters contained in the secondary communication path allocation information have the same meaning as the parameters contained in the primary communication path allocation information, and thus description thereof will be omitted. If compare the secondary communication path data in a period 518 in FIG. 5, the time slot start position is set at “8” and the number of time slots is set at “2.” Also, in the secondary communication path shown in FIG. 1, the transmission angle is 60° and the reception angle is 120°.

In this way, by referring to various parameters contained in the time-slot allocation information, the source node 100 and destination node 110 can send and receive application data and control data by controlling the antenna directivity angle with predetermined timing.

Next, overall operation according to the present embodiment will be described with reference to a sequence diagram. Four operations will be described herein: operation of a training process, operation during transmission of video data, operation performed if an error persists during transmission of video data, and operation performed to reselect a communication path anew.

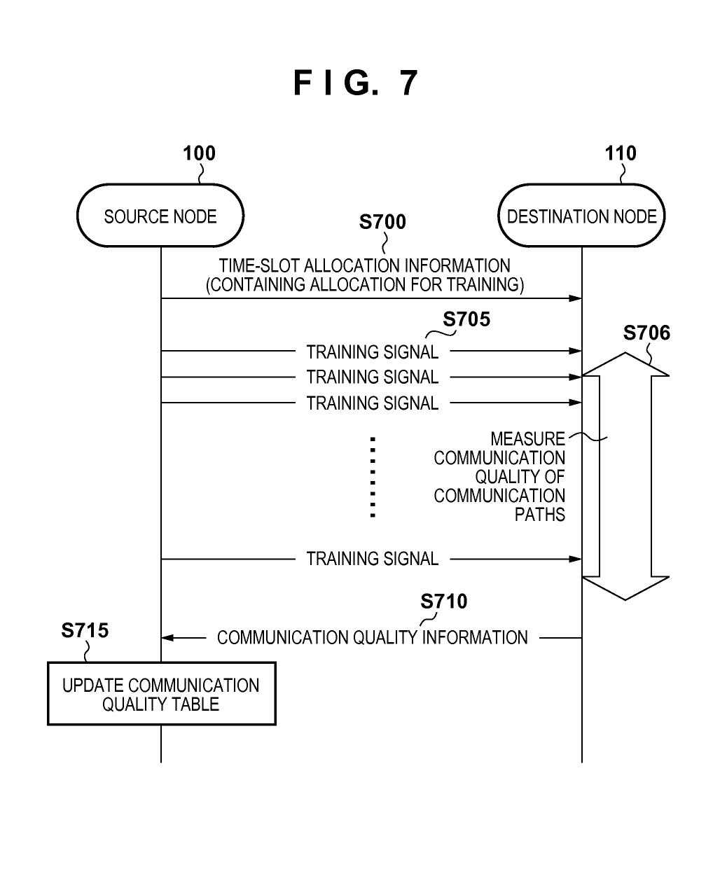

First, the operation of a training process will be described. A training process is performed before transmission of application data to measure the communication quality of the communication paths. The source node 100 collects the communication quality information produced as a result of the measurement, selects the primary communication path and secondary communication path to be used, based on the communication quality table, and determines the compression ratios of the video data. FIG. 7 is a diagram showing an operational sequence of the training process.

First, in S700, the source node 100 sends the time-slot allocation information containing an allocation for training to the destination node 110 and thereby notifies the destination node 110 about the start of the training process. Subsequently, in S705, the source node 100 sends a training signal for a predetermined period by changing the antenna directivity angle with predetermined timing. On the other hand, in S706, upon receiving the time-slot allocation information containing an allocation for training, the destination node 110 receives the training signal and measures communication quality by changing the antenna directivity angle with predetermined timing. By means of this process, the destination node 110 can measure the communication quality of the communication paths at various combinations of the transmission directivity angle of the source node 100 and reception directivity angle of the destination node 110. When all measurements of the communication quality are completed, the destination node 110 sends measurement results of the communication quality to the source node 100 in S710.

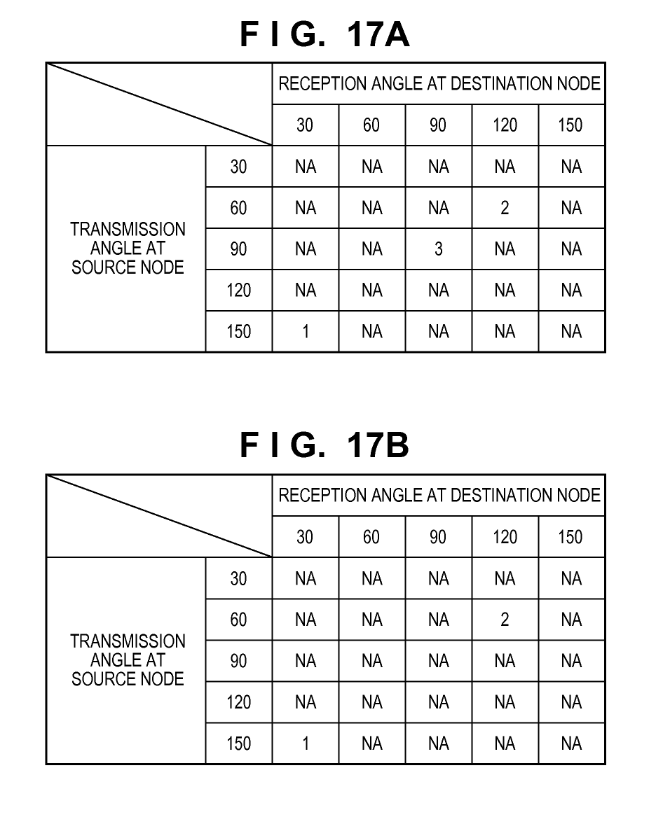

Next, in S715, the source node 100 saves the received measurement results of the communication quality in the communication quality table 220 and thereby updates the communication quality table 220. As a result, a communication quality table such as shown in FIG. 17A is created. Each cell in FIG. 17A represents a communication quality level of a communication path at a combination of a predetermined transmission directivity angle of the source node 100 and predetermined reception directivity angle of the destination node 110. The communication quality level is represented by a numeric value of 1 to 3, where the larger the numeric value, the better the communication quality.

Incidentally, NA (Not Applicable) means that the communication quality of the given cell was too poor to be measured. For example, the communication quality of the communication path is 1 when data is sent from the source node 100 at a directivity angle of 150° and received by the destination node 110 at a directivity angle of 30°. In this example, there are three candidates for the communication path to be used.

Next, an outline of operation performed to transmit video data after the training process is finished will be described with reference to FIG. 1. As shown in FIG. 1, the source node 100 transmits video data with different compression ratios through the primary communication path 141 and secondary communication path 140. Consequently, the video data can be played back within the validity period of the video data as long as the data can be received through one of the communication paths.

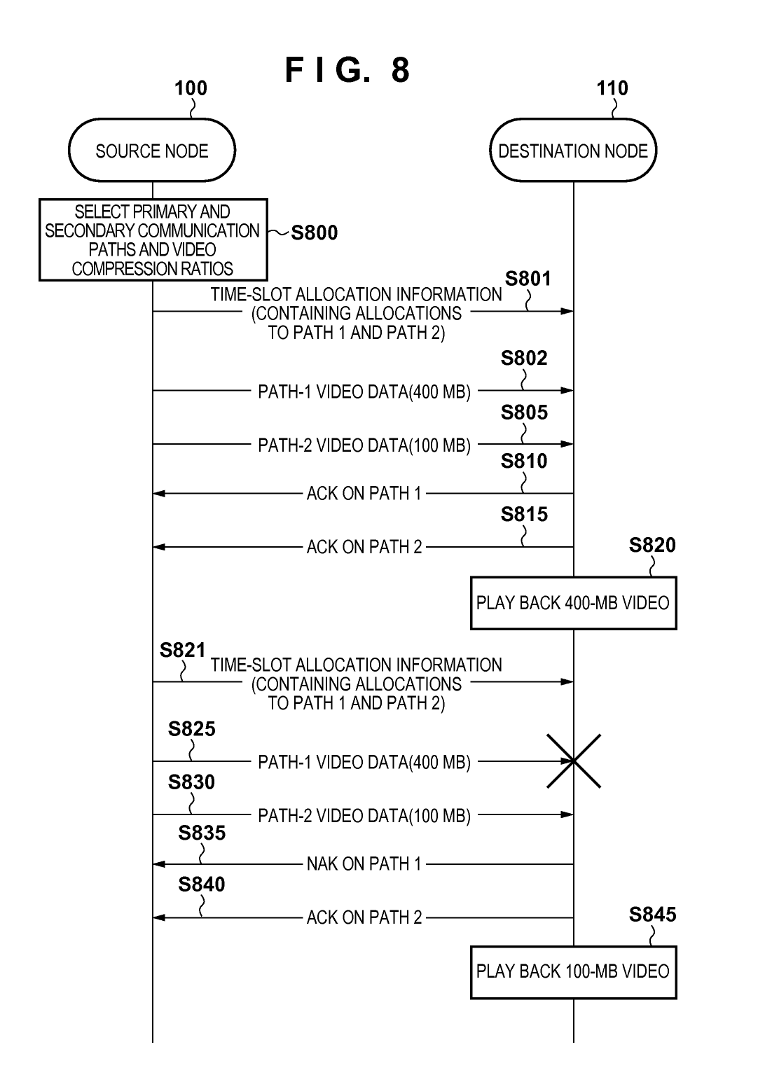

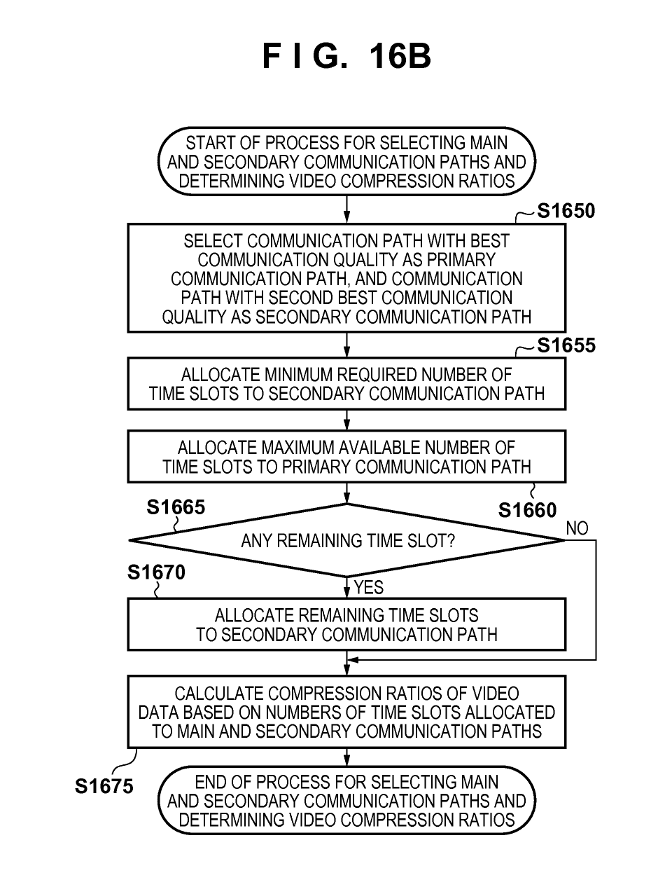

Now, an operational sequence used to transmit video data between the source node 100 and destination node 110 will be described in detail with reference to FIG. 8. First, in S800, the source node 100 selects the primary communication path and secondary communication path used for transmission of the video data, based on the communication quality table 220 and determines the compression ratios of the video data transmitted through the communication paths. Details of the process will be further described later with reference to FIG. 16B.

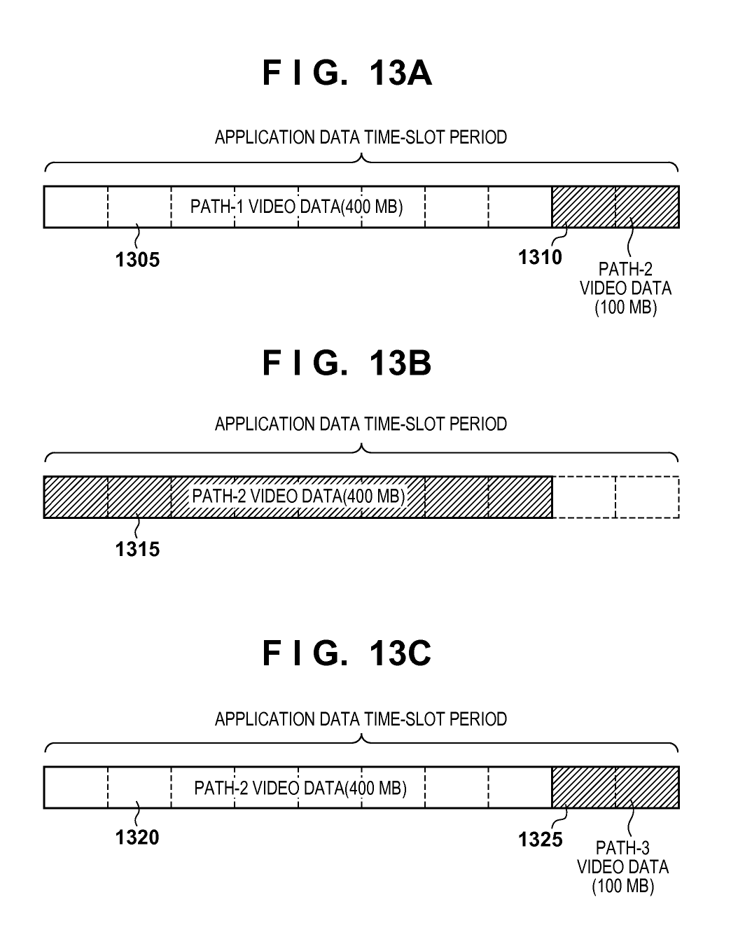

In this example, from among plural candidates for the communication paths, path 1 is selected as the primary communication path and path 2 is selected as the secondary communication path. FIG. 13A shows time-slot allocations of an application data time-slot period to video data 1305 on path 1 and video data 1310 on path 2.

S801 to S820 are processes performed when no error occurs on the primary communication path and secondary communication path. In S801, the source node 100 generates time-slot allocation information for path 1 and path 2 based on the selected communication paths and compression ratios of the video data and notifies the destination node 110 about the information. Subsequently, in S802, based on the time-slot allocation information, the source node 100 sends low-compression video data 400 MB in size using path 1 which is the primary communication path. Next, in S805, the source node 100 sends high-compression video data 100 MB in size using path 2 which is the secondary communication path.

After receiving the video data successfully through path 1 and path 2, the destination node 110 sends an ACK on path 1 in S810 and an ACK on path 2 in S815. When the video data is received successfully through both communication paths, the destination node 110 selects and plays back the high-quality, 400-MB video data in S820.

S821 to S845 are processes performed when an error occurs on the primary communication path. First, in S821, the source node 100 sends the same time-slot allocation information as in S801. If a reception error occurs on path 1, but the video data is received successfully through path 2 as shown in S825 and S830, the destination node sends an NAK on path 1 in S835 and an ACK on path 2 in S840. Then, the destination node plays back the low-quality, 100-MB video data received successfully.

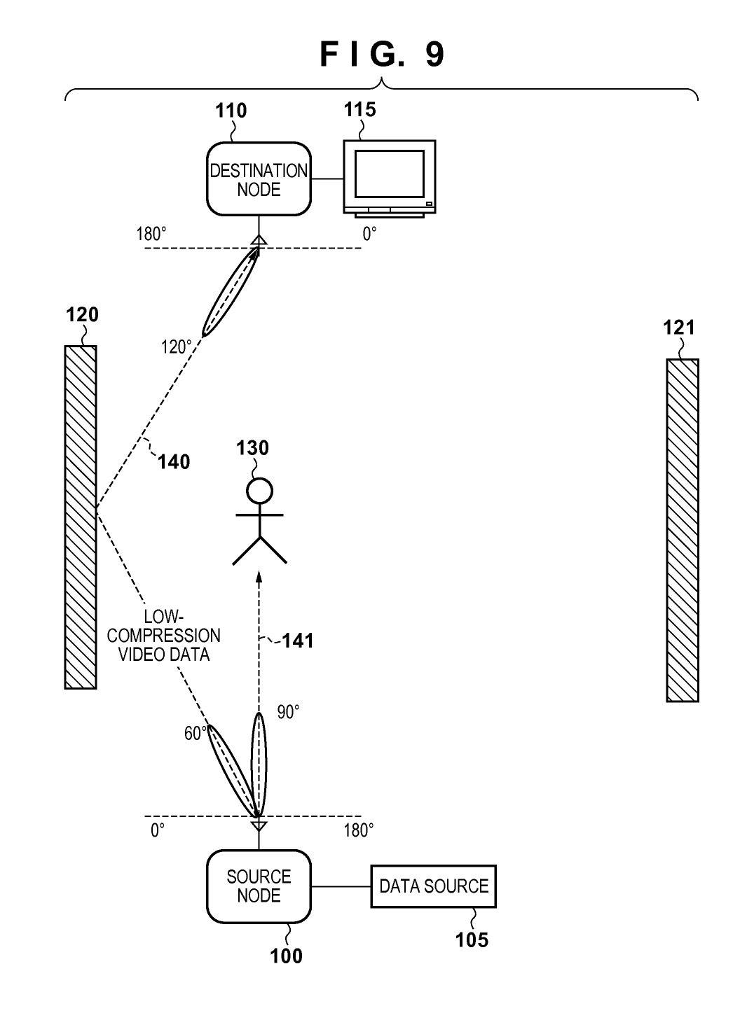

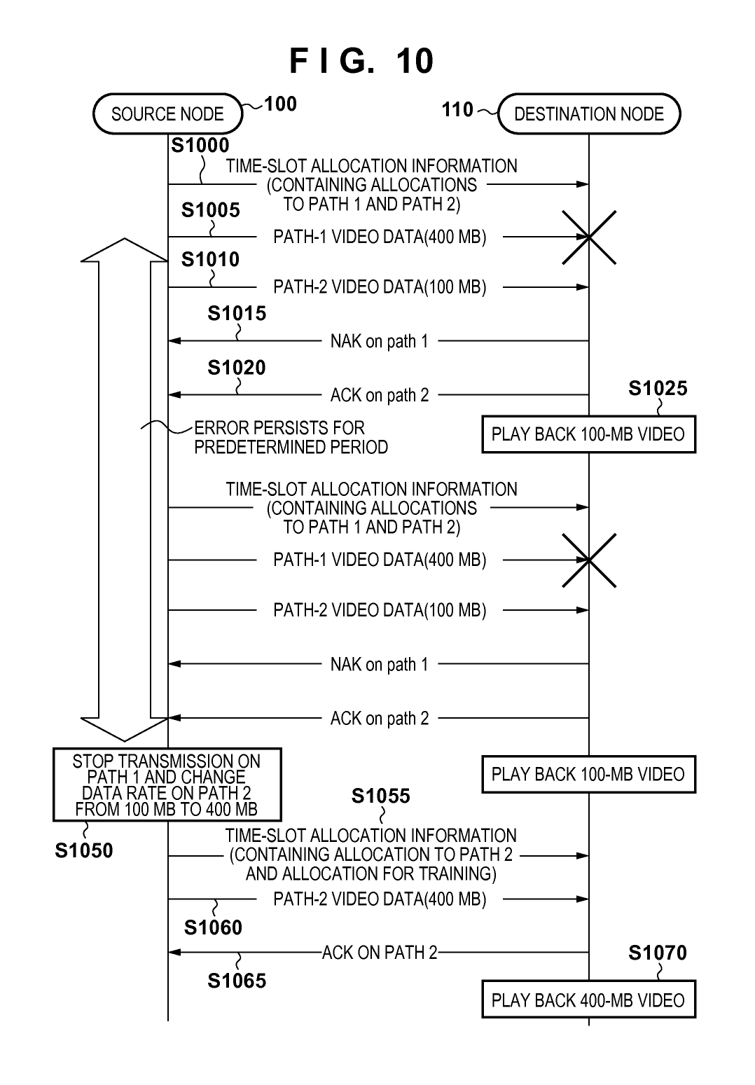

Now, an outline of operation performed if an error persists on the primary communication path during transmission of video data in the video data transmission operation will be described with reference to FIG. 9. An error will persist if a screening object 130 appears on the primary communication path 141 shown in FIG. 9. In that case, the data transmission on the primary communication path 141 is stopped, the compression ratio of the video data on the secondary communication path 140 is reduced, and low-compression video data is sent to prevent degradation of video quality. An operational sequence used in this case will be described with reference to FIG. 10.

In S1000 to S1025, video data is transmitted from the source node 100 to the destination node 110, which fails to receive the video data on path 1 and sends an NAK. Subsequently, the destination node 110 keeps failing to receive the video data on path 1. In the meantime, the destination node 110 plays back the 100-MB video data. On the other hand, the source node 100 determines that an error persists if an NAK is received for a predetermined period or no ACK is received for a predetermined period. In S1050, the source node 100 stops transmitting the video data on path 1, and the high-compression video data on path 2 as well. Then, the source node 100 reduces the compression ratio of the video data on path 2 and changes the data size from 100 MB to 400 MB. FIG. 13B is a diagram showing time-slot allocations of an application data time-slot period made when the data size is changed due to an error.

In S1055, the source node 100 sends new time-slot allocation information to the destination node 110 to reflect the data rate change to path 2, the time-slot allocation information containing an allocation to path 2 and an allocation for training, where the allocation for training is intended to request the destination node 110 to do retraining of path 2. In S1060, the source node 100 sends the 400-MB video data through path 2. Upon receiving the data on path 2 properly, the destination node 110 sends an ACK in S1065 and plays back the 400-MB, high-quality video in S1070.

In this way, even when a transmission error persists on the primary communication path, if the source node 100 sends the video data by changing the data rate of the secondary communication path, the destination node 110 can play back high-quality video.

Next, an outline of operations performed to search for and use a new communication path when a transmission error persists on the primary communication path will be described with reference to FIG. 11. When a transmission error persists on the primary communication path in use, a training process is performed again and a new communication path is searched for. In FIG. 11, a new communication path 142 is used because a transmission error has persisted on the communication path 141 shown in FIG. 9. This makes it possible to transmit video data using two communication paths again, and thereby improve the reliability of communication.

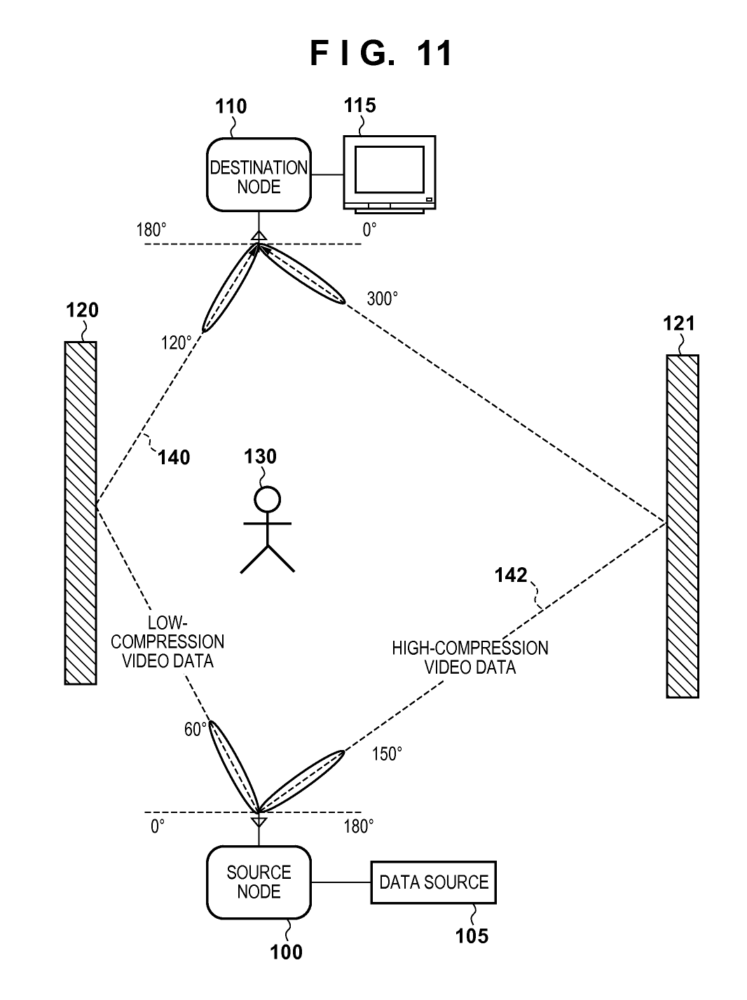

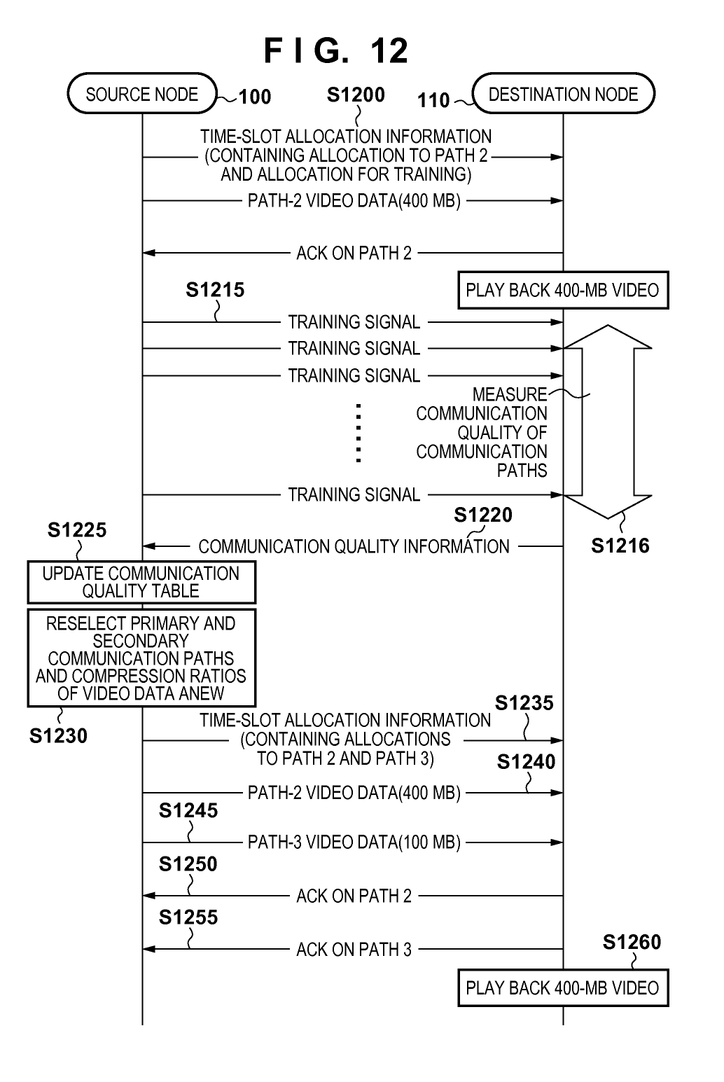

Now, an operational sequence for reselecting a communication path anew will be described with reference to FIG. 12. Since the error persists on path 1, the source node 100 sends time-slot allocation information containing an allocation for training to request the destination node 110 to do retraining (S1200). After transmission of video data, the source node 100 sends a training signal (S1215). On the other hand, the destination node 110 receives the training signal by changing the antenna directivity angle with predetermined timing (S1216) and thereby measures the communication quality of each communication path. Then, the destination node 110 notifies the source node 100 about the communication quality information (S1220). Upon receiving the communication quality information, the source node 100 updates the communication quality table (S1225).

FIG. 17B is a diagram showing an updated communication quality table. Unlike in FIG. 17A, since a screening object exists on path 1, the communication quality of path 1 with a transmission angle of 90° and a reception angle of 90° is rated as NA. Based on the communication quality table, a path 2140 is selected as the primary communication path and a path 3142 is selected as the secondary communication path.

The source node 100 selects the communication paths and the compression ratios of the video data (S1230), generates time-slot allocation information for path 2 and path 3, and sends the information to the destination node 110 (S1235). FIG. 13C is a diagram showing time-slot allocations of an application data time-slot period. As illustrated in FIG. 13C, video data 1320 on path 2 and video data 1325 on path 3 are included.

Subsequently, based on the time-slot allocation information, the source node 100 sends low-compression video data 400 MB in size using path 2 which is the primary communication path (S1240). Next, the source node 100 sends high-compression video data 100 MB in size using path 3 which is the secondary communication path (S1245). After receiving the video data successfully through path 2 and path 3, the destination node 110 sends an ACK on path 2 and an ACK on path 3 (S1250 and S1255). When the video data is received successfully through both communication paths, the destination node 110 selects and plays back the high-quality, 400-MB video data (S1260).

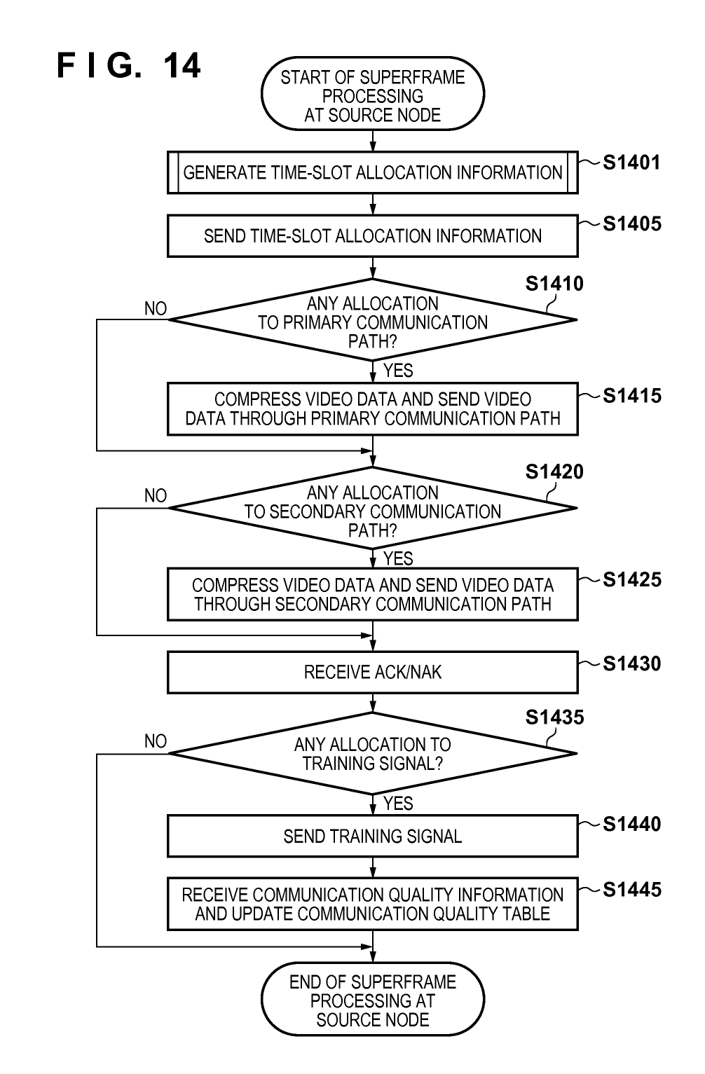

Next, details of internal operations of the source node 100 and destination node 110 will be described with reference to FIGS. 14 and 16A. FIG. 14 is a flowchart showing superframe processing at the source node 100.

First, in S1401, the source node 100 generates time-slot allocation information. Details of this process will be described later with reference to FIG. 16A. Next, in S1405, the source node 100 sends the generated time-slot allocation information to the destination node 110. Next, in S1410, the source node 100 determines whether or not there is any time-slot allocation to the primary communication path. If there is no allocation, the source node 100 branches to S1420, but if there is any allocation, the source node 100 branches to S1415. In S1415, the source node 100 compresses the video data at a predetermined compression ratio specified in the time-slot allocation information and sends the video data under conditions specified for the primary communication path, i.e., at the specified antenna directivity angle and at the time specified for transmission.

Next, in S1420, the source node 100 determines whether or not there is any time-slot allocation to the secondary communication path. If there is no allocation, the source node 100 branches to S1430, but if there is any allocation, the source node 100 branches to S1425. In S1425, the source node 100 compresses the video data at a compression ratio specified in the time-slot allocation information and sends the video data under conditions specified for the secondary communication path, i.e., at the specified antenna directivity angle and at the timing specified for transmission. Next, in S1430, the source node 100 receives an ACK/NAK from the destination node. Then, in S1435, the source node 100 determines whether or not there is any time-slot allocation to a training signal. If there is no allocation, the source node 100 finishes the superframe processing. On the other hand, if there is any allocation, the source node 100 sends a training signal in S1440 by changing the antenna directivity angle with predetermined timing. Then, the source node 100 receives communication quality information from the destination node 110, updates its own communication quality table in S1445, and thereby finishes the superframe processing.

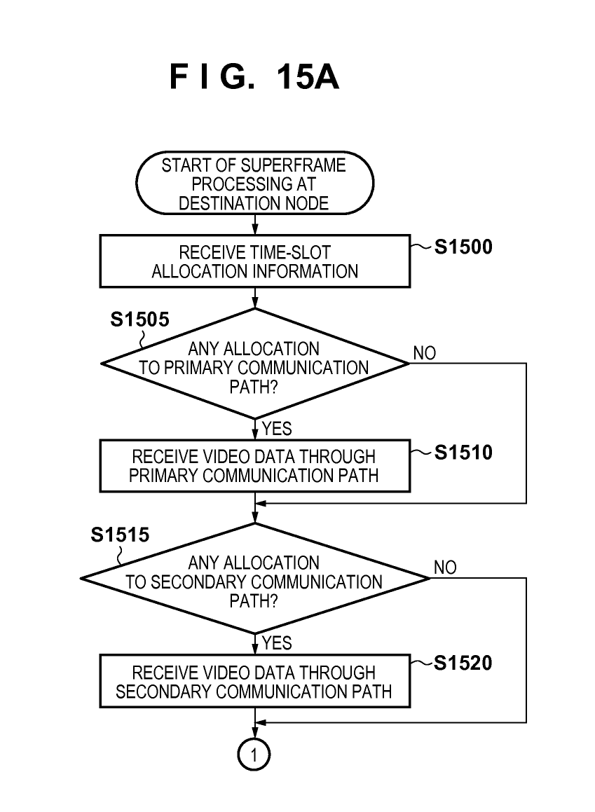

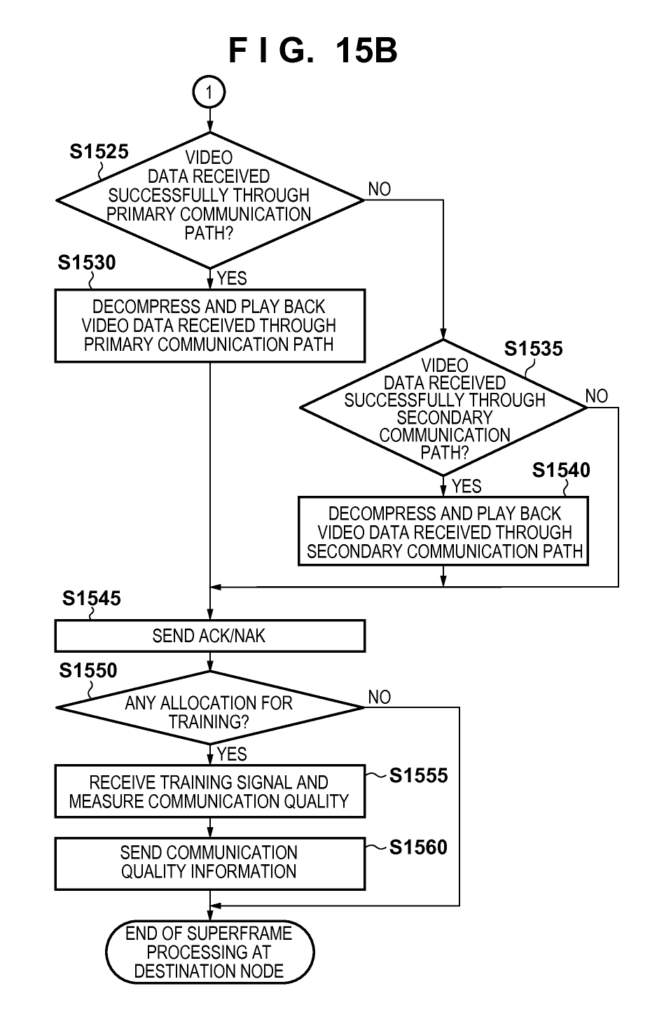

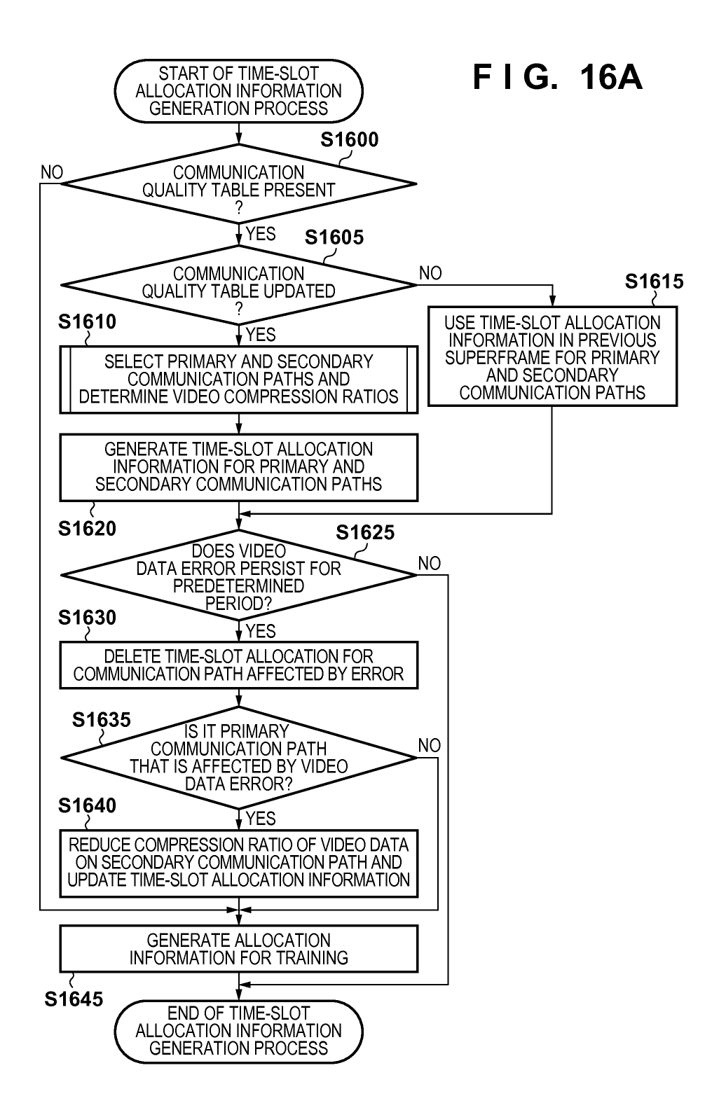

Next, superframe processing at the destination node 110 will be described with reference to FIGS. 15A and 15B. First, in S1500, the destination node 110 receives the time-slot allocation information from the source node 100. In S1505, by referring to the time-slot allocation information, the destination node 110 determines whether or not there is any allocation to the primary communication path. If there is no allocation, the destination node 110 branches to S1515, but if there is any allocation, the destination node 110 branches to S1510. In S1510, the destination node 110 receives the video data under conditions specified for the primary communication path set in the time-slot allocation information, i.e., at the specified antenna directivity angle and at the time specified for reception. Next, in S1515, by referring to the time-slot allocation information, the destination node 110 determines whether or not there is any allocation to the secondary communication path. If there is no allocation, the destination node 110 branches to S1525, but if there is any allocation, the destination node 110 branches to S1520. In S1520, the destination node 110 receives the video data under conditions specified for the secondary communication path in the time-slot allocation information, i.e., at the specified antenna directivity angle and at the time specified for reception.

Next, in S1525, the destination node 110 determines whether or not the video data has been received successfully through the primary communication path. If the video data has been received successfully, in S1530, the destination node 110 decompresses and plays back the high-quality, low-compression video data transmitted through the primary communication path, based on compression ratio information contained in the time-slot allocation information. On the other hand, if the reception of the video data is unsuccessful, the destination node 110 branches to S1535 to determine whether or not the video data has been received successfully through the secondary communication path. If the video data has been received successfully, in S1540, the destination node 110 decompresses and plays back the video data transmitted through the secondary communication path based on the compression ratio information contained in the time-slot allocation information. On the other hand, if the reception of the video data is unsuccessful, the destination node 110 branches to S1545 to sends an ACK/NAK to the source node 100, indicating results of reception on the primary communication path and secondary communication path.

Next, in S1550, by referring to the time-slot allocation information, the destination node 110 determines whether or not there is any allocation for training. If there is no allocation, the destination node 110 finishes the superframe processing. On the other hand, if there is any allocation, the destination node 110 receives a training signal and measures the communication quality of each communication path in S1555 by changing the antenna directivity angle with predetermined timing. Then, the destination node 110 sends communication quality information based on the measured communication quality to the source node 100 in S1560, and thereby finishes the superframe processing.

Next, details of a time-slot allocation information generation process (S1401 in FIG. 14) at the source node 100 will be described with reference to FIG. 16A. First, in S1600, the source node 100 determines whether or not a communication quality table has been generated in the source node 100. If no communication quality table has been generated, the source node 100 branches to S1645 because a training process is required to select a communication path for use to transmit video data. On the other hand, if a communication quality table has been generated, the source node 100 branches to S1605 to determine whether or not the communication quality table has been updated, i.e., whether or not a training process has been performed before the current superframe. If the communication quality table has not been updated, the source node 100 branches to S1615, where the source node 100 uses the same time-slot allocation information as the one used in the previous superframe without changing the time-slot allocation information for the primary communication path and secondary communication path. If the communication quality table has been updated, the source node 100 branches to S1610 to select a primary communication path and secondary communication path according to a new communication quality table and determine the video compression ratio for each communication path. Then, in S1620, the source node 100 generates time-slot allocation information for the primary communication path and secondary communication path based on the selected communication paths and compression ratios of the video data.

Next, in S1625, the source node 100 determines whether or not an error persists on the primary communication path or secondary communication path for a predetermined period. If there is no error on either communication path, the source node 100 finishes the time-slot allocation information generation process. If an error persists on either communication path, the source node 100 branches to S1630. In S1630, to stop the data transmission on the communication path on which the error persists, out of the time-slot allocation information generated in S1620, the source node 100 deletes the allocation information for the communication path on which the error persists. Next, in S1635, the source node 100 determines whether or not the communication path on which the error persists is the primary communication path. If it is the primary communication path, in S1640, the source node 100 reduces the compression ratio of the video data on the secondary communication path and updates the time-slot allocation information for the secondary communication path. If no communication quality table has been generated or if it is necessary to update the communication quality table because an error persists on a communication path, the source node 100 generates allocation information for training in S1645 to request a training process from the destination node 110.

Now, the process of selecting the primary and secondary communication paths and determining the video compression ratios (S1610 in FIG. 16A) will be described with reference to FIGS. 16B, 17A, and 17B. It is assumed that the minimum required number of time slots for the secondary communication path is two and that the video data size allowed to be sent per time slot is 50 MB. Also, it is assumed in the example described herein that the amount of uncompressed video data received from the data source 105 per superframe is 500 MB and that the communication quality table shown in FIG. 17A is used.

First, in S1650, by referring to the communication quality table, the source node 100 selects the communication path with the best communication quality as the primary communication path, and the communication path with the second best communication quality as the secondary communication path. Consequently, a communication path with a transmission angle of 90° and a reception angle of 90° is selected as the primary communication path and a communication path with a transmission angle of 60° and a reception angle of 120° is selected as the secondary communication path. Then, in S1665, the source node 100 allocates the minimum required number of time slots, specifically two time slots, to the secondary communication path. At this point, the number of remaining time slots is 8. Next, in S1660, the source node 100 allocates the maximum available number of time slots to the primary communication path. Since the number of remaining time slots is 8, 400 MB (=50*8) of data can be transmitted. On the other hand, since the amount of data before compression is 500 MB, all the 8 time slots are allocated to the primary communication path.

Next, in S1665, the source node 100 determines whether or not there is any remaining time slot. If the number of remaining time slots is zero at that period of time, the source node 100 branches to S1675. However, if there is any remaining time slot, the source node 100 branches to S1670 to allocate the time slots not used for the primary communication path to the secondary communication path. Then, in S1675, the source node 100 calculates the compression ratios of the video data based on the number of time slots allocated to the primary communication path and secondary communication path as well as on the amount of video data before compression. In this example, the compression ratio on the primary communication path, which transmits 400 MB of data, is 400/500=0.8 while the compression ratio on the secondary communication path, which transmits 100 MB of data, is 100/500=0.2. As a result of the above processes, antenna directivity angle conditions and compression ratio information of the selected communication paths are stored in the time-slot allocation information.

Whereas an exemplary embodiment of the present invention has been described above, needless to say, the present invention is not limited to this. Also, although the application data handled in the exemplary embodiment is video data, this is not restrictive, and, for example, audio data may be handled as well.

The present invention makes it possible to send data with a high level of quality even if an error occurs on a communication path, and thereby improve the reliability of communications and prevent degradation in the quality of the sent data.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-090407, filed Apr. 14, 2011, which is hereby incorporated by reference herein in its entirety.

What is claimed is:

1. A source node that sends data to a destination node, the source node comprising:
a sending unit that sends data either uncompressed or compressed at a predetermined compression ratio through a first communication path and send data compressed at a high compression ratio than the predetermined compression ratio through a second communication path different from the first communication path; and
a changing unit that changes the compression ratio of data sent through the second communication path from the high-compression ratio into either uncompressed or the predetermined compression ratio in case that an error occurs on the first communication path.

2. The source node according to claim 1, further comprising a searching unit that searches for a new communication path in case that the compression ratio of data sent through the second communication path is changed by said changing unit into either uncompressed or the predetermined compression ratio,
wherein said sending unit sends the data compressed at the high compression ratio through the new communication path found by the search.

3. The source node according to claim 1, wherein at least one of the source node and the destination node controls an antenna directivity angle.

4. The source node according to claim 1, wherein said sending unit sends data using a plurality of communication paths that differ in the antenna directivity angle.

5. The source node according to claim 1, wherein said changing unit changes the compression ratio of data sent through the second communication path into either uncompressed or the predetermined compression ratio in case that an error persists on the first communication path for a predetermined period.

6. A sending method for a source node that sends data to a destination node, the method comprising:
sending data either uncompressed or compressed at a predetermined compression ratio through a first communication path and sending data compressed at a high compression ratio than the predetermined compression ratio through a second communication path different from the first communication path; and
changing the compression ratio of data sent through the second communication path from the high-compression ratio into either uncompressed or the predetermined compression ratio in case that an error occurs on the first communication path.

7. A wireless communication system comprising:
a source node that comprises a sending unit that sends data either uncompressed or compressed at a predetermined compression ratio through a first communication path and send data compressed at a high compression ratio than the predetermined compression ratio through a second communication path different from the first communication path, and a changing unit that changes the compression ratio data sent through the second communication path into either uncompressed or the predetermined compression ratio in case that an error occurs on the first communication path; and
a destination node that receives data from the source node.

8. A computer readable recording medium having recorded thereon a program for causing a computer to execute the sending method according to claim 6.
